(19) United States
(12) Patent Application Publication
(10) Pub. No.: US 2006/0177617 A1
(43) Pub. Date: Aug. 10, 2006

(54) Ribbed joint patch for single ply roofing membranes

(75) Inventor: Edward Nebesnak, Mine Hill, NJ (US)

Correspondence Address: Attn: William J. Davis, Esq.;GAF MATERIALS CORPORATION, Legal Department, Building No. 8, 1361 Alps Road, Wayne, NJ, 07470, US

(73) Assignee: BUILDING MATERIALS INVESTMENT CORPORATION

(21) Appl. No.: 11/055,148

(22) Filed: Feb. 10, 2005

(51) Int. Cl. B32B 33/00

(52) U.S. Cl. 428/40.1; 428/119; 428/156

(57) ABSTRACT

A ribbed roof T-joint or butt joint patch is provided for application to intersecting and overlapping portions of a single ply membrane of different heights. When applied to the joint formed by the intersecting and overlapping membranes, the ribbed joint patch having an adhesive layer conforms to the void formed by the joint and assures a water tight seal. A method of making a roof joint patch and a method of applying a ribbed joint patch to a void formed by intersecting and overlapping membranes are also disclosed.

### FIELD OF THE INVENTION

The present invention relates to roofing materials. More specifically, the present invention is directed to a patch to fill voids created by overlapping roofing membranes.

### BACKGROUND OF THE INVENTION

Single ply membranes are roofing membranes that are field applied using just one layer of membrane material (either homogeneous or composite) rather than multiple layers. Oftentimes as a result of the overlapping intersection of two, three or four sheets of the membrane, a joint is created.

Current joint patches are flat membranes with the butyl or similar adhesive applied to one side with a release liner. Often, when applied to intersecting and overlapping portions of a single ply membrane of different heights, the adhesive does not conform to the vertical step in height thus causing bridging and leaving a void into which water and debris can enter.

### SUMMARY OF THE INVENTION

When roofing membranes intersect or overlap with one another, joints may be formed at the points of intersection or overlap. A T-joint is a joint formed by the intersection or overlapping of three or four membrane sheets. A butt-joint is a joint formed by adjacent, separate sections of material, such as where two neighboring pieces of roofing membrane abut. The joints formed by the intersection and/or overlapping of roofing membranes can be problematic since the void formed by the joint permits water to seepage into and underneath the roofing membranes.

A joint patch is provided to alleviate the problem inherent in the formation of “joints” formed as a result of the overlapping intersection of sheets in the roofing membrane. In one embodiment, the T-joint patch is ribbed and may be circular, oval, square or rectangle. The patch is comprised of a single ply roofing membrane preferably ranging in size from approximately 3 inches to 9 inches. Examples of single ply roofing membranes from which the patch is formed includes, but is not limited to, thermoplastic olefin (TPO), polyvinyl chloride (PVC), ethylene propylene diene terpolymer (EPDM) or chlorosulfonated polyethylene (Hypalon®).

The joint patch can be injection molded or fabricated by other conventionally known methods, with a rib or similar design having an approximate height of 20-90 mils on the flat plane of the membrane that will receive a butyl or other type of adhesive compound and a release liner. This design will allow for the adhesive to fill in the void created by the overlapping membranes thus assuring a tight seal.

### BRIEF DESCRIPTION OF THE FIGURES

FIG. 1 depicts overlapping membranes forming a T-joint or void;

FIG. 2 is a perspective view of a circular T-joint patch in accordance with one embodiment of the present invention;

FIG. 3 illustrates a top view of the T-joint patch of FIG. 2 secured in the T-joint formed by the overlapping membranes;

FIG. 4 illustrates another top view of the T-joint patch of FIG. 2 secured in the T-joint formed by the overlapping membranes;

FIG. 5 illustrates a view of the roof side of a joint patch having two ribs which segment the patch into four quadrants;

FIG. 6 illustrates a top view of the a joint patch in which a single rib, segmenting the patch into halves, is seen in skeletal view;

FIG. 7 illustrates a top view of the joint patch of FIG. 6 secured in the joint formed by the overlapping membranes;

FIG. 8 illustrates a top view of a butt-joint patch secured in the joint formed by the overlapping membranes.

### DETAILED DESCRIPTION

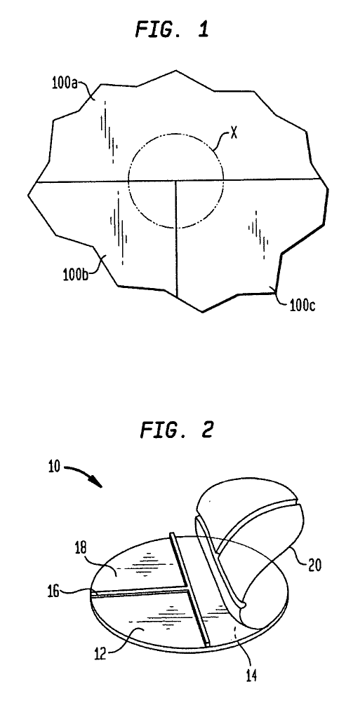

In FIG. 1, a joint, commonly referred to as a T-joint, (indicated by the circle denoted X) is formed by the intersection of three (3) membranes 100a, 100b, 100c. A first embodiment of the T-joint patch 10 is illustrated in FIG. 2. Patch 10 in one embodiment is circular or oval. Patch 10 is planar and has a first side 12 (roof side) and a second side 14 (weather side). A T-shaped rib 16 is positioned on first side 12. T-shaped rib 16 divides first side 12 of patch 10 into three sections. A layer of adhesive 18 such as a butyl layer or other similar waterproofing adhesive layer, is then coated on T-shaped 16 and first side 12 of patch 10. A release liner 20 is then positioned on first side 12 of patch 10 and conforms to the shape of patch 10. Patch 10 is not limited to a circular or oval shape and may also be square or rectangular.

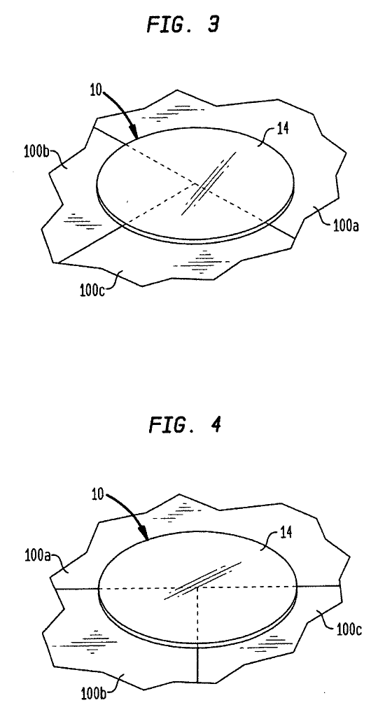

In use, release liner 20 is peeled or removed from first side 12 of patch 10. The T-shaped rib 16 is then positioned to conform with the T-joint formed by the intersection of membranes 100a, 100b, 100c and is fitted in the T-joint. Adhesive layer 18 on first side 12 of patch 10 secures side 12 of patch 10 to membranes 100a, 100b, 100c. To provide a water-tight seal, pressure is usually applied to second side 14 of patch 10. Pressure may be applied by any known means, including the use of a roller or by applying pressure using one's hands. Heat may also be applied to second side 14 of patch 10 to provide a heat seal. FIGS. 3 and 4 illustrate patch 10 applied on membranes 100a, 100b, 100c. T-shaped rib is positioned in T-shaped joint (not visible), and adhesive layer 12 secures first side 12 of patch 10 to membranes 100a, 100b, 100c, leaving second side 14 as the exposed surface.

T-joint patch 10, in one embodiment, is a single ply roofing membrane ranging in size from approximately 3 inches to 9 inches, but the size and shape of the patch is not limited in this respect. Examples of single ply roofing membranes from which patch 10 is formed include thermoplastic olefin (TPO), polyvinyl chloride (PVC), ethylene propylene diene terpolymer (EPDM) or chlorosulfonated polyethylene (Hypalon®). The T-joint patch can be vacuum or injection molded, or fabricated by other conventionally known methods, with a T-shaped rib having an approximate height of 20-90 mils on the flat plane of the membrane that will receive a butyl or other type of adhesive compound and a release liner.

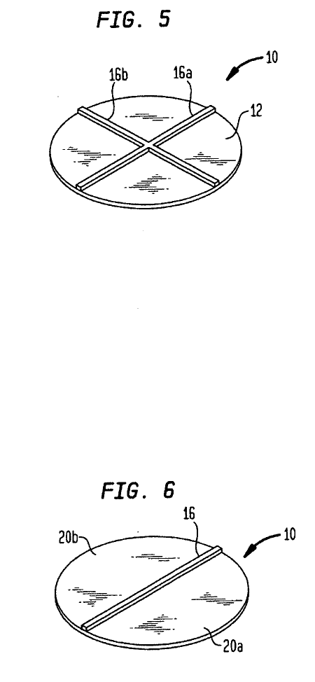

In a second embodiment illustrated in FIG. 5, joint patch 10 is vacuum or injection molded and segmented (or divided) into four quadrants by intersecting ribs 16, 16b. Each quadrant formed by the intersection of ribs 16a, 16b have a different height and having the same thickness of butyl or other adhesive layer thereon, along with a release liner (not shown).

In a third embodiment, joint patch is segmented into four quadrants as in FIG. 5. In this embodiment, the four quadrants formed by intersecting ribs, combined with the butyl layer (or other adhesive layer), and the release liner, all have a different thickness. The difference in the thickness of the quadrants is to accommodate the differences in height of intersecting roofing membranes, which are oftentimes placed on top of one another such that one or more sides of a of a joint may be higher than other sides.

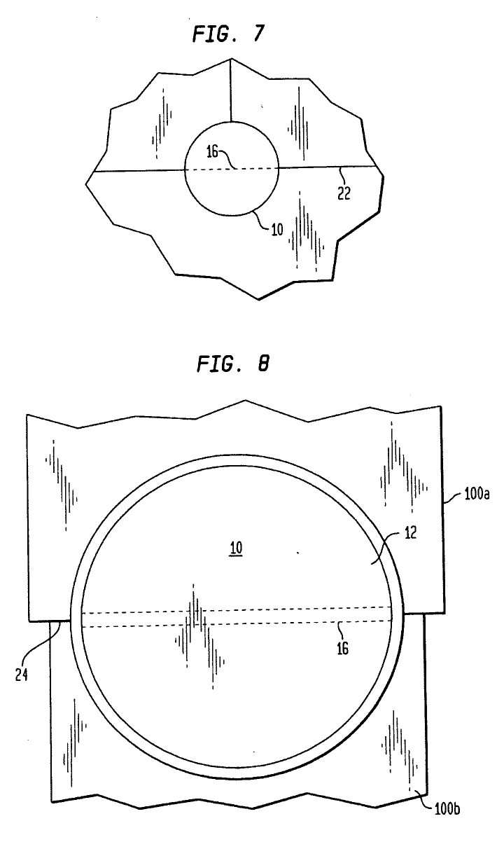

In another embodiment illustrated in FIG. 6, a joint patch 10 is segmented into two sections 20a, 20b by a single rib 16. Sections 20a and 20b may or may not be equal halves. Each of sections 20a, 20b are provided with a butyl layer or other adhesive layer, and a release liner. Furthermore, each of sections 20a, 20b has a different thickness. FIG. 7 illustrates joint patch 10 of FIG. 6 applied on membranes 100a, 100b, 100c in a horizontal joint 22.

In another embodiment in accordance with the present invention, patch 10 may be used for sealing a butt joint formed by adjacent, separate sections of material, such as roofing membrane sheets. A butt joint patch generally has a single rib on the deck side of the patch and extending from one side of the patch to the other side, much like patch 10 illustrated in FIGS. 6 and 7. The single rib on the deck side of the patch generally splits butt joint patch into two equal sections, however the invention is not limited in this respect, and rib may divide butt joint patch into unequal sections. As with the other joint patches described herein, the butt joint patch will also be provided on its deck side with a butyl layer or other adhesive layer, and a release liner on the butyl or other adhesive layer. The butt joint patch in accordance with the present invention can be vacuum molded, injection molded or fabricated by other conventionally known methods.

FIG. 8, illustrates butt joint patch 10 having a single rib 16 on its deck side positioned in a butt joint 24 formed by the intersection/overlapping of membrane 100a and 100b.

In still another embodiment there is provided a butt joint patch having a vacuum or injection molded membrane having a single rib 16 which segments the membrane into two sections of two different heights, each segment having the same thickness of butyl or other adhesive layer thereon, along with a release liner.

What is claimed is:

1. A roof joint patch, comprising:
a. a flat section of roofing membrane;
b. one or more ribs positioned on the surface of one side of the section of roofing membrane;
c. an adhesive waterproofing layer applied on the flat section of roofing membrane having the rib positioned thereon;
d. a release liner applied on the adhesive layer.

2. The joint patch as recited in claim 1, wherein the flat section of roofing membrane is circular, oval, square or rectangular in shape.

3. The joint patch as recited in claim 2, wherein the flat section of the roofing membrane is circular or oval.

4. The joint patch as recited in claim 1, wherein the flat section of roofing membrane is a single ply roofing membrane selected from the group consisting of: thermoplastic olefin, polyvinyl chloride, ethylene propylene diene terpolymer or chlorosulfonated polyethylene.

5. The joint patch as recited in claim 4, wherein the single ply roofing membrane is vacuum or injection molded.

6. The joint patch as recited in claim 1, wherein the flat section of roofing membrane ranges in size from approximately 3-9 inches.

7. The joint patch as recited in claim 1, wherein the one or more ribs has a height in the range of approximately 20-90 mils.

8. The joint patch as recited in claim 1, wherein the adhesive layer is a butyl layer or other similar waterproofing compound.

9. The joint patch as recited in claim 1, wherein the one or more ribs segment the patch into two, three or four sections.

10. The joint patch as recited in claim 9, wherein each of the sections on the patch are provided with the adhesive waterproofing layer and a release liner, and wherein each section has a different height.

11. The joint patch as recited in claim 9, wherein each of the sections on the patch are provided with the adhesive waterproofing layer and a release liner, and wherein the thickness of the adhesive waterproofing layer and the release liner on each section is different.

12. The joint patch as recited in claim 1, wherein the one or more ribs conform to a joint formed by overlapping roofing membrane sheets such that the rib on the patch fills in the joint to create a water tight seal.

13. The joint patch as recited in claim 12, wherein the joint is a T-joint or a butt joint.

14. A T-joint patch, comprising:
a. a flat section of roofing membrane;
b. a T-shaped rib positioned on the surface of one side of the flat section of roofing membrane;
c. an adhesive waterproofing layer applied on the flat section of roofing membrane having the T-shaped rib positioned thereon; and
d. a release liner applied on the adhesive layer.

15. The T-joint patch as recited in claim 14, wherein the flat section of roofing membrane is circular, oval, square or rectangular in shape.

16. The T-joint patch as recited in claim 15, wherein the flat section of the roofing membrane is circular or oval.

17. The T-joint patch as recited in claim 14, wherein the flat section of roofing membrane is a single ply roofing membrane selected from the group consisting of: thermoplastic olefin, polyvinyl chloride, ethylene propylene diene terpolymer or chlorosulfonated polyethylene.

18. The T-joint patch as recited in claim 17, wherein the single ply roofing membrane is vacuum or injection molded.

19. The T-joint patch as recited in claim 14, wherein the flat section of roofing membrane ranges in size from approximately 3-9 inches.

20. The T-joint patch as recited in claim 14, wherein the T-shaped rib has a height in the range of approximately 20-90 mils.

21. The T-joint patch as recited in claim 14, wherein the adhesive layer is a butyl layer or other similar waterproofing compound.

22. The T-joint patch as recited in claim 14, wherein the T-shaped rib conforms to a T-joint formed by intersecting and/or overlapping roofing membranes such that the T-shaped rib on the T-joint patch fills in the T-shaped joint to create a water tight seal.

23. The T-joint patch as recited in claim 14, wherein the T-shaped rib segments the patch into three sections.

24. The T-joint patch as recited in claim 23, wherein each of the three sections are provided with the adhesive waterproofing layer and the release liner, and wherein each section has a different height.

25. The T-joint patch as recited in claim 23, wherein each of the three sections are provided with the adhesive waterproofing layer and the release liner, and wherein the thickness of the adhesive waterproofing layer and the release liner on each segment is different.

26. A method of making a roof joint patch:
a. forming one or more ribs on a flat section of a single ply roofing membrane;
b. coating the one or more ribs and flat section of a singly ply roofing membrane with an adhesive layer; and
c. adding a release liner on the adhesive layer.

27. The method of claim 10, further comprising the step of positioning the one or more ribs in a joint formed by the intersection and/or overlapping roofing membrane sheets on a roof such that the one or more ribs are secured in the joint to form a water tight seal.

28. The method of claim 10, wherein the joint patch comprises a flat section of single ply roofing membrane selected from the group consisting of:
thermoplastic olefin, polyvinyl chloride, ethylene propylene diene terpolymer or chlorosulfonated polyethylene.

29. The joint patch as recited in claim 12, wherein the single ply roofing membrane is vacuum or injection molded.

30. The joint patch as recited in claim 12, wherein the flat section of single ply roofing membrane ranges in size from approximately 3-9 inches.

31. The joint patch as recited in claim 10, wherein the one or more ribs have a height in the range of approximately 20-90 mils.

32. The joint patch as recited in claim 10, wherein the adhesive layer is a butyl layer.

33. The joint patch as recited in claim 10, wherein the flat section of singly ply roofing membrane is circular or oval.

34. The joint patch as recited in claim 1-0, wherein the flat section of single ply roofing membrane is square or rectangular in shape.

35. A method of filling a joint void formed by overlapping membranes, the method comprising the steps of:
a. peeling a release liner off a T-joint patch having a T-shaped rib on a flat section of single ply roofing membrane;
b. positioning the T-shaped rib so as to correspond to the T-joint void formed by overlapping membranes on a roofing surface; and
c. applying pressure on a reverse surface of the flat section of single ply roofing membrane such that the T-shaped rib fills the T-joint void to form a water tight seal.

36. The method as recited in claim 19, wherein the T-joint patch comprises flat section of single ply roofing membrane selected from the group consisting of:
thermoplastic olefin, polyvinyl chloride, ethylene propylene diene terpolymer or chlorosulfonated polyethylene.

37. The method as recited in claim 20, wherein the single ply roofing membrane is vacuum or injection molded.

38. The method as recited in claim 20, wherein the flat section of single ply roofing membrane ranges in size from approximately 3-9 inches.

39. The method as recited in claim 19, wherein the T-shaped rib has a height in the range of approximately 20-90 mils.

40. The method as recited in claim 19, wherein the adhesive layer is a butyl layer.

41. The method as recited in claim 19, wherein the flat section of singly ply roofing membrane is circular or oval.

42. The method as recited in claim 19, wherein the flat section of single ply roofing membrane is square or rectangular in shape.

43. The method as recited in claim 19, further comprising the step of:
a. applying heat on the reverse surface of the flat section of the single ply roofing membrane to provide a heat seal.

44. The method as recited in claim 35, wherein the joint is a T-joint or a butt joint.

45. A roof joint patch, comprising:
a. a flat section of roofing membrane;
b. one or more ribs positioned on the surface of one side of the section of roofing membrane and which segments the membrane into 2, 3 or 4 sections.;
c. an adhesive waterproofing layer applied on the flat section of roofing membrane having the rib positioned thereon;
d. a release liner applied on the adhesive layer.

46. The joint patch as recited in claim 45, wherein the flat section of roofing membrane is circular, oval, square or rectangular in shape.

47. The joint patch as recited in claim 46, wherein the flat section of the roofing membrane is circular or oval.

48. The joint patch as recited in claim 46, wherein the flat section of roofing membrane is a single ply roofing membrane selected from the group consisting of: thermoplastic olefin, polyvinyl chloride, ethylene propylene diene terpolymer or chlorosulfonated polyethylene.

49. The joint patch as recited in claim 48, wherein the single ply roofing membrane is vacuum or injection molded.

50. The joint patch as recited in claim 45, wherein the flat section of roofing membrane ranges in size from approximately 3-9 inches.

51. The joint patch as recited in claim 45, wherein the one or more ribs have a height in the range of approximately 20-90 mils.

52. The joint patch as recited in claim 45, wherein the adhesive layer is a butyl layer or other similar waterproofing compound.

53. The joint patch as recited in claim 45, wherein each of the sections on the patch are provided with the adhesive waterproofing layer and a release liner, and wherein each section has a different height.

54. The joint patch as recited in claim 45, wherein each of the sections on the patch are provided with the adhesive waterproofing layer and a release liner, and wherein the thickness of the adhesive waterproofing layer and the release liner on each section is different.

55. The joint patch as recited in claim 45, wherein the one or more ribs conform to a joint formed by intersecting and/or overlapping roofing membrane sheets such that the rib on the patch fills in the joint to create a water tight seal.

56. The joint patch as recited in claim 55; wherein the joint is a T-joint or a butt joint.

57. A patch for sealing a joint formed by the intersection and/or overlapping of two or more roofing membrane sheets, comprising:
a. one or more ribs positioned on the surface of one side of a flat section of roofing membrane and which segment the roofing membrane into 2, 3 or 4 sections;
b. an adhesive waterproofing layer applied on the flat section of roofing membrane having the one or more ribs positioned thereon;
c. a release liner applied on the adhesive layer.

58. The patch as recited in claim 57, wherein the flat section of roofing membrane is circular, oval, square or rectangular in shape.

59. The patch as recited in claim 58, wherein the flat section of the roofing membrane is circular or oval.

60. The patch as recited in claim 57, wherein the flat section of roofing membrane is a single ply roofing membrane selected from the group consisting of:
thermoplastic olefin, polyvinyl chloride, ethylene propylene diene terpolymer or chlorosulfonated polyethylene.

61. The patch as recited in claim 60, wherein the single ply roofing membrane is vacuum or injection molded.

62. The joint patch as recited in claim 57, wherein the flat section of roofing membrane ranges in size from approximately 3-9 inches.

63. The patch as recited in claim 57, wherein the one or more ribs have a height in the range of approximately 20-90 mils.

64. The patch as recited in claim 57, wherein the adhesive layer is a butyl layer or other similar waterproofing compound.

65. The patch as recited in claim 57, wherein each of the sections on the patch are provided with the adhesive waterproofing layer and a release liner, and wherein each section has a different height.

66. The patch as recited in claim 57, wherein each of the sections on the patch are provided with the adhesive waterproofing layer and a release liner, and wherein the thickness of the adhesive waterproofing layer and the release liner on each section is different.

67. The patch as recited in claim 57, wherein the one or more ribs conform to a joint formed by intersecting and/or overlapping roofing membrane sheets such that the rib on the patch fills in the joint to create a water tight seal.

68. The patch as recited in claim 67, wherein the joint is a T-joint or a butt joint.

69. A butt joint patch, comprising:
a. a flat section of roofing membrane;
b. a single rib positioned on the surface of one side of the flat section of roofing membrane, the rib segmenting the surface of the flat section of roofing membrane into two sections;
c. an adhesive waterproofing layer applied on the flat section of roofing membrane having the rib positioned thereon; and
d. a release liner applied on the adhesive layer.

70. The butt joint patch as recited in claim 69, wherein the flat section of roofing membrane is circular, oval, square or rectangular in shape.

71. The butt joint patch as recited in claim 70, wherein the flat section of the roofing membrane is circular or oval.

72. The butt joint patch as recited in claim 69, wherein the flat section of roofing membrane is a single ply roofing membrane selected from the group consisting of: thermoplastic olefin, polyvinyl chloride, ethylene propylene diene terpolymer or chlorosulfonated polyethylene.

73. The butt joint patch as recited in claim 72, wherein the single ply roofing membrane is vacuum or injection molded.

74. The butt joint patch as recited in claim 69, wherein the flat section of roofing membrane ranges in size from approximately 3-9 inches.

75. The butt joint patch as recited in claim 69, wherein the T-shaped rib has a height in the range of approximately 20-90 mils.

76. The butt joint patch as recited in claim 69, wherein the adhesive layer is a butyl layer or other similar waterproofing compound.

77. The butt joint patch as recited in claim 69, wherein the rib conforms to a butt joint formed by intersecting and/or overlapping roofing membranes such that the rib on the butt joint patch fills in the joint to create a water tight seal.

78. The butt joint patch as recited in claim 69, wherein each of the two sections are provided with the adhesive waterproofing layer and the release liner, and wherein each section has a different height.

79. The butt joint patch as recited in claim 69, wherein each of the two sections are provided with the adhesive waterproofing layer and the release liner, and wherein the thickness of the adhesive waterproofing layer and the release liner on each segment is different.
